(19) United States
(12) Patent Application Publication
(10) Pub. No.: US 2011/0087609 A1
(43) Pub. Date: Apr. 14, 2011

(54) System and Method for Providing a Value Returned Home Service Contract

(75) Inventor: Douglas Stein, Miami Shores, FL (US)

(73) Assignee: CROSS COUNTRY HOME SERVICES, INC., Sunrise, FL (US)

(21) Appl. No.: 12/900,941

(22) Filed: Oct. 8, 2010

Related U.S. Application Data
(60) Provisional application No. 61/250,289, filed on Oct. 9, 2009.

(51) Int. Cl. G06Q 50/00

(52) U.S. Cl. 705/313

(57) ABSTRACT

A method for providing a value returned home service contract includes providing, to a contract purchaser, a service contract on at least one property owned by a contract holder, and checking a status of the home service contract to determine whether a claim has been made by the contract holder within a predetermined period of time. If the contract holder has not made a claim within the predetermined time, the method may then provide the contract holder with additional value.

### PRIORITY

This patent application claims priority from U.S. Provisional Patent Application No. 61/250,289, filed Oct. 9, 2009, entitled, “System and Method for Providing A Value Returned Home Service Contract,” and naming Douglas Stein as inventor, the disclosure of which is incorporated herein, in its entirety, by reference.

### FIELD OF THE INVENTION

The invention generally relates to home service contracts (sometimes referred to as home warranties or home protection plans), and more particularly, the invention relates to systems and methods for providing value returned home service contracts.

### BACKGROUND

One of the major concerns when purchasing and owning a home is the age, condition, and maintenance of both the home and the major systems and appliances within the home. For example, many potential buyers and home owners are concerned that, after purchasing and moving into their new home (or remaining within their existing home), one or more of the major home systems or appliances will fail, resulting in a sizeable and unexpected repair or replacement bill. In today's economic climate any unexpected expenses can be troubling. As one may expect, this concern over unexpected system and appliance failure may reduce a buyers confidence in the home, which, in turn, may lower the value of the home and the price which an owner or seller may receive for the property. Additionally, such unexpected failures and bills may be disconcerting and/or troublesome for an existing homeowner.

### SUMMARY OF THE INVENTION

In accordance with some embodiments of the present invention, a method for providing a value returned home service contract may include providing a contract purchaser with a service contract on a property owned by a contract holder, and checking the status of the home service contract to determine whether a claim (e.g., a paid claim or an unpaid claim) has been made by the contract holder within a predetermined period of time. If the contract holder has not made a claim within the predetermined period of time, the method may then make an additional value available to the contract holder, for example, based upon the length of the predetermined period of time, whether a claim was made, and/or whether the claim was a paid claim or not. The predetermined period of time may be within the first nine months of the term of the home service contract and/or the home service contract may be a multi-year service contract. The contract purchaser may be the same as the contract holder

In accordance with some embodiments, the additional value may be a free or partially covered/reimbursed maintenance visit on a home system, a free maintenance visit on one or more home appliances, a cash-back reward, a full or partial refund of the premium, an extension of a term of the service contract, a free energy audit, or a rebate on future repairs, to name but a few. The home service contract may be limited in nature, not covering certain types of potential claims such as missing appliances, missing home systems, rust and corrosion, and abuse to the home.

In some embodiments, a remainder of the service contract may remain after the predetermined period. During this remainder of the service contract (e.g., after receiving the additional value), the contract holder is able to make claims. The cost of the home service contract may be independent from the size, age and condition of the property.

In accordance with other embodiments, a system for providing a value returned home service contract may include a processor and a memory for storing instructions that are executable by the processor to perform a variety of processes. The processes may include (1) providing a contract purchaser with a service contract on a property owned by a contract holder, (2) checking or monitoring the status of the home service contract to determine whether a claim (e.g., a paid claim) has been made by the contract holder within a predetermined period of time (e.g., within the first 9 or 10 months of the term of the service contract), and (3) making an additional value (e.g., a free maintenance visit on a home system, a free maintenance visit on a home appliance, a cash-back reward, an extension of the service contract term, a free energy audit, or a rebate on future repairs) available to the contract holder if the contract holder does not make a claim within the predetermined time. Additionally or alternatively, the contract holder may contact the home service contract provider to inform the home service contract provider that the contract holder has earned the additional value and redeem the additional value. The processes may then include checking the status of the service contract to determine if a claim or a paid claim was made and whether or not to make the additional value available to the contract holder.

The memory may also include instructions executable by the processor to receive and process claims made by the contract holder. For example, the contract holder may make the claim by entering the information into the system and/or a website (e.g., as mentioned below) or the contract holder may call a contract provider representative that may, in turn, enter the claim information. The processor may also determine when the contract holder makes a claim within the predetermined period of time. The system (e.g., the processor within the system) may also include a timer that tracks the term of the service contract and the predetermined period of time.

In some embodiments, a remainder of the service contract may remain after the predetermined period. During this remainder of the service contract (e.g., after receiving the additional value), the contract holder is able to make claims. The cost of the home service contract may be independent from the size, age and condition of the property.

In accordance with further embodiments, a system for providing a value returned home service contract may include means for providing, to a contract purchaser, a service contract on at least one property owned by a contract holder, and means for checking a status of the home service contract to determine whether a claim has been made by the contract holder within a predetermined period of time. The system may also have means for offering the contract holder an additional value if the contract holder does not make a claim or have a paid claim within the predetermined period of time.

Additional embodiments may also have means for receiving and processing claims made by the contract holder. The means for receiving and processing the claims may notify the means for checking when the contract holder makes a claim within the predetermined period of time. The means for checking may also include a means for tracking a term of the service contract and the predetermined period of time (e.g., to allow the means for checking to determine whether a claim has been made within the predetermined time).

In accordance with still further embodiments, a computer-implemented method for providing a value returned home service contract may include providing, using a computer, to a contract purchaser or a contract holder, a service contract on a property owned by a contract holder. The computer implemented method may also check, within a computer process, a status of the home service contract to determine whether a claim has been made by the contract holder within a predetermined period of time (e.g., within the first nine months of a term of the home service contract). If the contract holder has not made a claim within the predetermined time period, the computer implemented method may then provide, using a computer process, the contract holder with an additional value (e.g., a free maintenance visit on a home system, a free maintenance visit on a home appliance, a cash-back reward, an extension of a term of the service contract, a free energy audit, or a rebate on future repairs).

In some embodiments, the home service contract may be a multi-year service contract and may not cover missing appliances, missing home systems, rust and corrosion, and abuse to the home. Additionally, if the contract purchaser or contract holder committed to purchase the service contract prior to selling the property, the service contract may increase the interest in and value of the property.

### BRIEF DESCRIPTION OF THE DRAWINGS

The foregoing features of the invention will be more readily understood by reference to the following detailed description, taken with reference to the accompanying drawings, in which:

FIG. 1 shows a flowchart showing the steps of one method for providing a value returned home service contract on a property, in accordance with embodiments of the present invention.

FIG. 2 schematically shows a system for providing a value returned home service contract on a property in accordance with embodiments of the present invention.

FIG. 3 schematically shows a block diagram of a computerized method for providing a value returned home service contract on a property, in accordance with an embodiment of the present invention.

FIG. 4 schematically shows an alternative embodiment of a system for providing a value returned home service contract on a property, in accordance with additional embodiments of the present invention.

### DESCRIPTION OF ILLUSTRATIVE EMBODIMENTS

Various embodiments of the present invention provide systems and methods for providing home owners or renters with a value returned home service contract that ensures that the contract holder will receive value from the service contract, even if the contract holder never makes a claim or never has a paid claim under the service contract. Specific embodiments offer a home service contract to the home owner, seller, renter, or their representative and provide the contract holder with an “additional value” if a claim is not made within a predetermined time (e.g., as determined at the time the home service contract is purchased). Details of illustrative embodiments are discussed below.

The described embodiments of the invention are intended to be merely exemplary and numerous variations and modifications will be apparent to those skilled in the art. All such variations and modifications are intended to be within the scope of the present invention as defined in the appended claims. For example, the term “home service contract” should be interpreted expansively to also include line protection programs that cover delivery of one or more utilities to the home. Additionally, the term “home service contract” may include protection programs for all or part of the home. For example, the home service contract may only protect items (e.g., appliances and systems) within the kitchen (e.g., a kitchen protection plan) or may only protect home appliances (e.g., an appliance protection program).

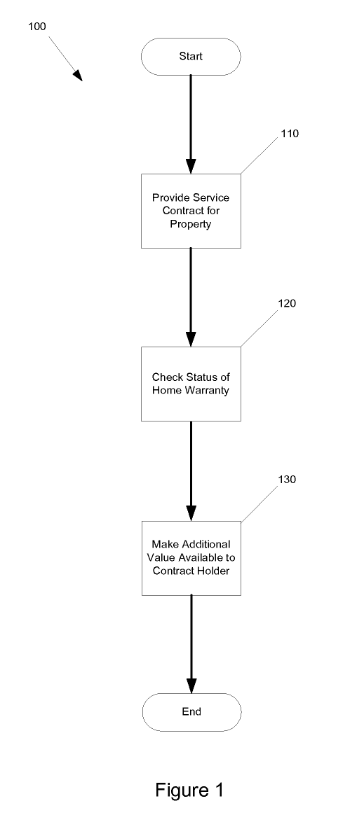

FIG. 1 shows one embodiment of a method in accordance with the present invention. According to the method 100, a home service contract company or other home maintenance company can provide the owner or the contract holder with a service contract on their property or properties (Step 110). It is important to note that, although a home owner is discussed above and throughout the present application, the home service contract company may provide similar warranties to other individuals or entities (e.g., a home renter/rental property). For example, the home service contract provider may provide the service contract to (e.g., it may be purchased by) a seller (such as a bank, mortgage lender, real estate agent, individual home seller or investor), a buyer, an existing homeowner, or a person renting a home.

The service contract can be for a variety of terms (e.g. six months, one year, two years, three years, etc.) and may cover a variety of the systems and appliances of the home. For example, the service contract may cover anything that goes wrong with the electrical and/or plumbing in the home. Additionally, the service contract may also be structured such that it does not cover other aspects of the home. For example, the service contract can be structured such that it does not cover missing appliances and systems (e.g., refrigerator, stove, A/C system), rust, corrosion, and intentional or negligent abuse (e.g., to air conditioning and heating systems, kitchen and laundry appliances, etc.).

Once the owner/buyer/seller (e.g., the contract purchaser) obtains the service contract provided to them by the home service contract company, the property is then considered “under service contract.” It is important to note that the person or entity actually purchasing the service contract may not be the owner or renter of the property and may not, ultimately, be the contract holder. For example, as discussed below, a real estate agent may be the contract purchaser and may be purchasing the the contract for a seller. In this instance, the buyer of the property may become the contract holder.

Additionally, as discussed in co-pending U.S. patent application Ser. No. 12/563,803, which is incorporated herein by reference in its entirety, the presence of the service contract provides an advantage over similar homes without warranties, and, if the property is being sold, the home service contract may accelerate the sale of the property. In addition, since damage and problems with the property may be covered under the service contract, if the property is for sale, potential buyers will be more confident in their purchase and may be more likely to offer a higher price for the home. Moreover, once the buyer is in the home, the cost of many repairs (or the cost of replacing appliances, etc.) may be covered under the service contract. Therefore, the buyer (e.g., the contract holder) may not be subject to unexpected expenses that may make it difficult for the buyer to pay the new mortgage. Even for ongoing home owners not buying or selling their home, a home service contract can provide valuable peace of mind in case coverage is ever needed.

Many prospective home service contract purchasers and holders may have reservations regarding the purchase of a home service contract, despite the benefits that a home service contract provides. For example, a purchaser may be concerned that they will never need the service contract (e.g., they will not have to make a claim) and, therefore, will not receive enough value/benefit from the service contract. Therefore, some embodiments of the present invention may include providing a “value returned” home service contract. To that end, systems and methods in accordance with some embodiments of the present invention may check and/or monitor the status of the service contract, for example, to determine when and if a home service contract claim is made by the contract holder (Step 120). This may involve a single check (e.g., by a representative of the home service contract provider) at the end of a pre-determined time period, or multiple/regular checks over that time period.

Additionally or alternatively, some embodiments may perform a single check in response to a request from a contract holder. For example, some embodiments may provide the contract holder with the additional value only if the contract holder requests the additional value. Therefore, when the contract holder contacts the service contract provider, some embodiments may check the status to determine if a claim was filed. If a home service contract claim was not made within the predetermined time period, the method 100 may then make an “additional value” available to the contract holder (Step 130). This additional value may be free of charge or may be provided at a reduced rate/cost.

The additional value can be any number of products or services that would be of interest to the contract holder. For example, the additional value may be a free maintenance visit for the home's HVAC system. Additionally or alternatively, the additional value may be a free maintenance visit on another home system, a free maintenance visit on a home appliance, a cash-back reward, an extension of the term of the service contract (e.g., an additional month may be added to the term of the service contract), a rebate on future repairs, a free energy audit, or a discount on other products and/or services, to name but a few. In some instances, the contract holder may be given a choice as to which additional value they would like to receive.

As mentioned above, the additional value may be provided or made available to the contract holder if a claim is not made within a predetermined time period. This predetermined time period may be determined when the home service contract is purchased and may be included in the service contract documentation and details (e.g., description of the service and/or warranty, terms and conditions of the home service contract, etc). Additionally, in some instances, the time period (and the additional value) may vary based upon the coverage and service contract term purchased. For example, if the contract purchaser purchased a 2 year home service contract, the predetermined time period may be 9 months (e.g., if the contract holder does not submit a home service contract claim or a claim is not paid within the first 9 months of the home service contract, the contract holder may receive a free air conditioning maintenance visit). In some embodiments, the contract holder may have a time window (e.g., 2 months) in which to claim and/or schedule (e.g., if it is a maintenance visit) the additional value. If the additional value is not claimed within the time window, the contract holder may lose the additional value.

In some embodiments, the home service contract provider may be billed directly and/or directly pay for the additional value. For example, if the additional value is a maintenance visit, the technician conducting the maintenance visit may directly bill the home service contract provider for the visit and the home service contract provider may then directly pay the technician for the visit. In other embodiments, the technician may bill the contract holder and the contract holder may then pay for the maintenance visit. The contract holder may then contact the home service contract provider (e.g., by submitting a receipt) in order to receive a full or partial reimbursement of the cost of the maintenance visit.

In accordance with some embodiments of the present invention, the additional value may be provided to the contract holder as long as a “paid claim” has not been made. In other words, if the contract holder makes a claim to the home service contract provider that is not ultimately paid out (e.g., if the claim is regarding a component, appliance, or piece of equipment that is not covered under the service contract), the contract holder may still receive the additional value at the end of the predetermined time period.

Some embodiments of the present invention may also provide/offer escalating additional values depending on whether a claim was made, a paid claim was made, and/or the length of time without a claim or paid claim. For example, if the contract holder makes a claim that is not subsequently paid (e.g., it was not a covered component, etc), the contact holder may be offered one additional value. Conversely, if the contract holder did not make any claims during the predetermined time period, the contract holder may receive a different, more valuable additional value (or the contract holder may receive multiple additional values).

In a manner similar to above, the contract holder may be offered escalating additional values based upon time. For example, if the contract holder has a 9 month predetermined period of time, they may be offered one additional value after the nine month period. However, if the contract holder does not accept/receive the additional value after the nine month period, the value and/or quantity of the additional value(s) may increase as more time passes. For example, if the contract holder still has not made a claim or paid claim after 14 months, the contract holder may be offered multiple additional values or an additional value of greater value.

Additionally, it is important to note that the predetermined time period typically falls within the term of the service contract such that the additional value is provided within the term of the service contract. For example, if the predetermined time period is the first 9 months of a two year home service contract, the contract holder still has 15 months of coverage remaining on the home service contract after the predetermined time period. Therefore, the contract holder is still free to make claims during the remainder of the service contract.

Furthermore, the cost of the service contract need not be based upon the individual property. For example, the cost may be independent from the age and condition of the property, appliances, and/or systems (e.g., the cost of the service contract would be the same if the property was 15 years old or 100 years old). To that end, the cost of the service contract may be based solely on the features and coverage of the service contract, the location of the property, and/or the type of property (e.g., single family home, condo, duplex, etc.). In such embodiments, the cost may not be based upon the age and condition of the property or the appliances (e.g., if the home has two air conditioning units, the cost of the service contract coverage for each air conditioning unit may be the same for an air conditioning unit in a different, perhaps older or newer, property). In this manner, some embodiments of the present invention may allow the home service contract providers to underwrite the service contract coverage on state or national level (e.g., as opposed to an individual level).

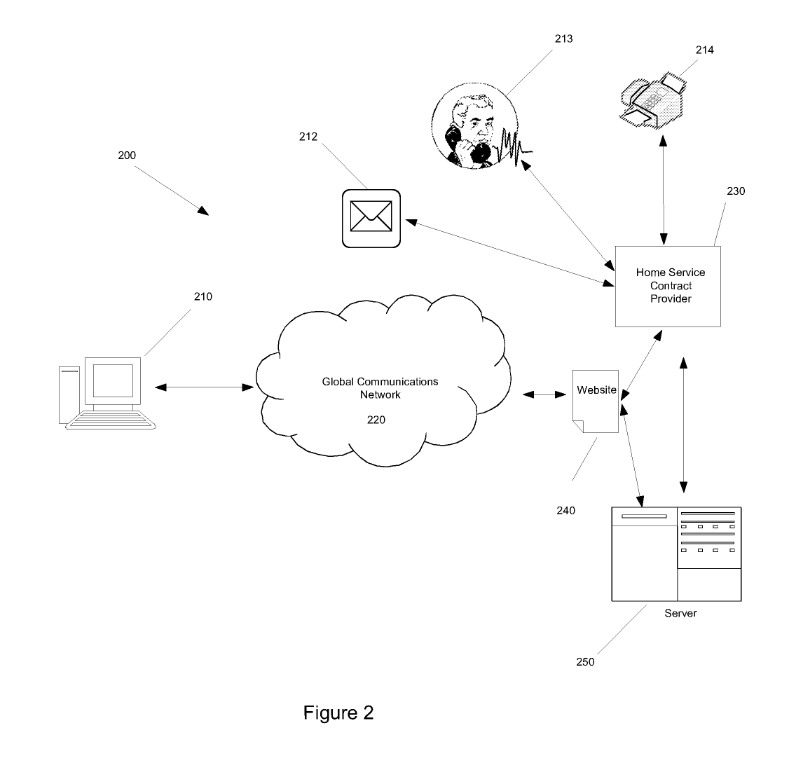

As mentioned above and as shown in FIG. 2 some embodiments of the present invention may be implemented as a value return system 200. For example, the value return system 200 may include a global data communications network 220, such as the internet. The value return system 200 may also include a server 250 that is in communication with the global communications network 220 and supports a website 240. The website 240 may consist of a plurality of web pages. The value return system 200 may also include one or more customer terminals 210 such as workstations within the banks, mortgage lenders, or real estate agency (e.g., those institutions selling the property). Additionally or alternatively, the terminals 210 may be the contract purchaser's personal computer, a workstation within other representatives of the home buyer and/or contract purchaser, or a third party that may be selling the home service contracts.

The customer terminals 210 may be in communication with the global communications network 220 to allow the customer terminals 210 and the contract purchaser (or the seller, purchaser, real estate agent, or third party) to access the website 240 (e.g., to purchase the home service contract). For example, the website 240 may be accessed and displayed by the workstations 210 over the global communications network 220. Further, the workstations 210 may send information back to the server 250 over the global communications network 220. Additionally or alternatively, the terminals 210 may be used (e.g., by a third party direct marketer or telemarketer selling the service contracts) to transfer a batch file (e.g., containing a list of contract holders and/or properties) to the home service contract provider 230, and/or server, 250. If necessary, a representative at the home service contract provider 230 may then manually input the information into the value return system 200 or otherwise extract the information from batch file.

Besides communications by workstations 210 over the global communications network 220, embodiments of the present invention may also support other communications methods such as by mail 212, phone calls 213, and/or fax 214. Communications such as mail 212, phone 213, and fax 214 allow contract purchasers and/or third party marketers to contact a representative of the home service contract provider to place their order. The representative may then input the necessary information into the system 200 described below and complete the transaction.

As mentioned above, the value return system 200 may also include the home service contract provider 230. The home service contract provider 230 may access and view the website 240 and access any data stored within the server 250. The home service contract provider 230 may also send information back to the server 250 (e.g., over the global communications network 220).

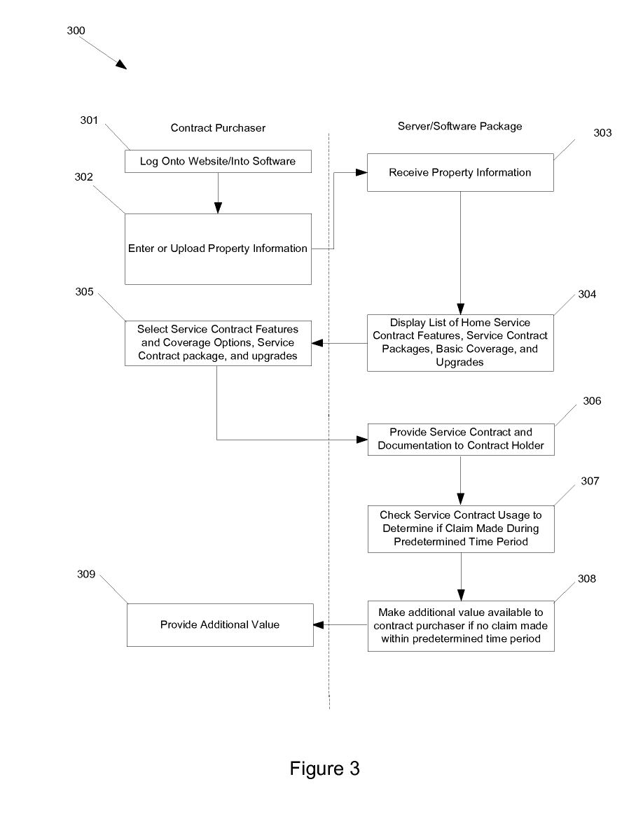

FIG. 3 shows a computerized method for providing a value returned home service contract in accordance with some embodiments of the present invention. As shown in FIG. 3, a user (e.g., the contract purchaser, the seller, etc.) may log onto the website 240 or software package (Step 301), for example, using one of the workstations 210 shown in FIG. 2. Once logged-in, the user may input or upload information regarding the property for which they wish to obtain a service contract (Step 302). For example, the user may manually input (e.g., by typing) the information regarding the property (e.g., address, condition and age of property, condition and age of appliances and utility equipment, etc.) or the user may upload the information (e.g., from a hard-drive, other memory on the workstation 210, or from an external memory device). In some embodiments, the property information may have been pre-established such as by data (e.g., in a batch file) from a third party such as a real estate agent or telemarketing organization.

As discussed above, in some embodiments, the cost of the service contract may not be dependent upon the individual home and the characteristics (e.g., age and condition) of the home and home systems/appliances. Therefore, in such embodiments, much of the inputted/uploaded information (e.g., the age of the home and the appliances/equipment) may be for informational purposes only. Additionally or alternatively, the information may be used by technicians when responding to a maintenance call (e.g., so they know which tools and/or parts may be needed) or by the home service contract provider when determining whether a component, appliance, piece of equipment, or home system should be replaced or repaired.

Although some of the embodiments described above receive a variety of information regarding the property (e.g., address, condition and age of property, condition and age of appliances and utility equipment, etc.), other embodiments of the present invention may only receive very limited information (e.g., the information required to purchase the service contract). For example, the user may merely enter/upload the address and type of property (e.g., single family, duplex, condo, etc.). In such embodiments, technicians responding to service calls may provide the home service contract provider with information regarding the appliances and/or systems, and may make suggestions as to whether to repair or replace the item after examining the appliance/system. The home service contract provider may then make a determination based upon the information and suggestions provided by the technician.

Once the property information is entered/uploaded, the server 250 or the software package may receive the property information (Step 303), and generate and/or display a list of service contract features, coverage options, and service contract packages (e.g., standard coverage) (Step 304) for the property (e.g., based upon the received information). For example, the list of service contract features may include a list of items that can be covered, the term of the service contract, deductible options (e.g., how much of a deductible the user would like), upgrade options, etc.

In alternative embodiments, the server/software package may display a list of standard (e.g., non-customizable) service contract packages that contain standard coverage. Or rather than one or more service contract packages as such, there may be a base coverage option and one or more optional coverage upgrades. For example, the user may select additional coverage for some of the unique appliances and systems that the property may contain (e.g., pool pumps and equipment, sump pumps, second refrigerator, second air conditioning units, etc.). If the service contracts are being sold by third party marketers (e.g., third party direct marketers or third party telemarketers), the service contracts offered may be a specific service contract with only limited variation.

The user (e.g., the home owner, seller, bank, mortgage lender, real estate agent, contract purchaser, or contract holder) may then select the service contract features (or service contract package) that they wish to purchase for the property (Step 305). For example, the user may select which appliances (e.g., stove, refrigerator, etc.) and systems (e.g., electrical, plumbing, HVAC) to cover as well as the type, length, and amount of coverage, including whether or not there is a deductible and the amount of the deductible. Alternatively, the user may select one of the standard service contract packages and any upgrades. Based upon the home service contract features and/or package selected and the property information, the computerized method 300 may provide service contract coverage (and any applicable service contract materials such as terms and conditions, etc.) to the contract purchaser, real estate agent, and/or the contract holder (Step 306). For example, this may occur at the time of closing of the home purchase transaction in the form of an invoice added to the closing paperwork, at which time payment is received by the service contract provider. In some instances, the materials regarding the service contract may be provided to the contract holder sometime thereafter.

As mentioned above, various embodiments of the present invention provide an additional value if the contract holder does not make a claim within a predetermined period of time (e.g., within the first 9 months of the service contract coverage). To that end, the computerized method 300 may check the usage of the home service contract to determine when claims are made and if a claim is made within the predetermined time period (Step 307). If the contract holder has not made a claim within the predetermined time period, the computerized method may then notify the contract holder of the availability of the additional value (e.g., using the global communications network 220), provide the contract holder with the additional value, and/or make the additional value available to the contract holder (Step 308). The contract holder may then receive the additional value, notification that the additional value is available, or, if an appointment must be scheduled (e.g., if the additional value is maintenance visit), the contract purchaser may schedule the appointment (Step 309).

As discussed above, some embodiments of the present invention base the availability of the additional value on whether a “paid claim” has been made by the contract purchaser. To that end, the computerized method (e.g., at Step 307) may also determine if a claim has been or will be paid (e.g., whether it is a paid claim). If the claim is not a paid claim, the computerized method may then (e.g., at Step 308) provide the contract holder with the additional value. If the claim is a paid claim, the method may not provide the additional value.

As mentioned above, some embodiments only provide the additional value when requested by the contract holder (e.g., it is not provided automatically). Therefore, in some embodiments, the computerized method may check the service contract usage only after receiving a request from the contract holder. The computerized method 300 may then make the additional value available to the contract holder if no claim (or if no claim was paid) during the predetermined period of time.

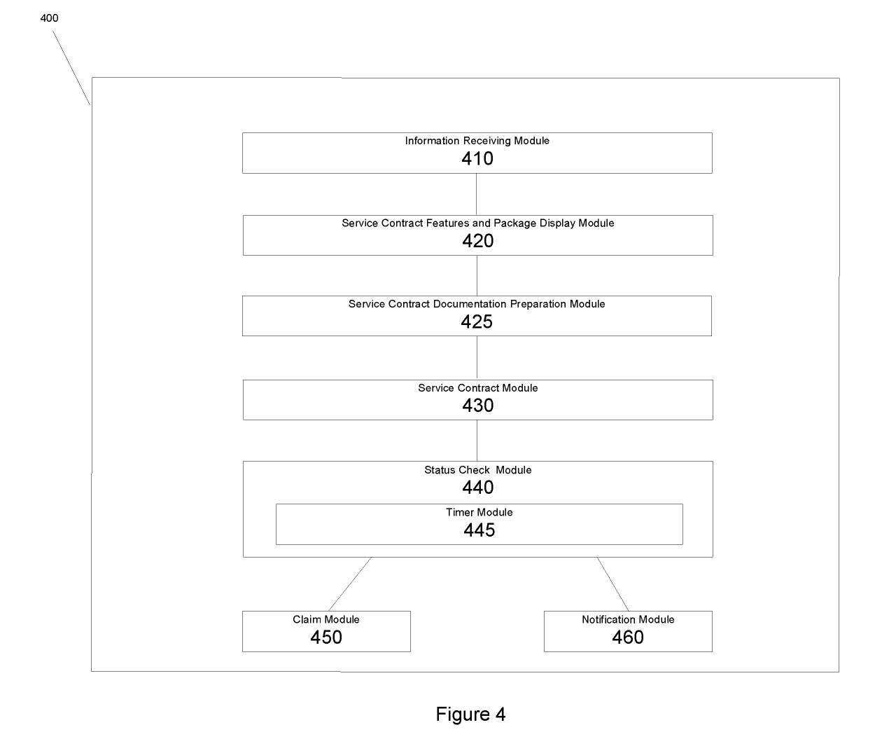

As shown in FIG. 4, some embodiments of the present invention may include a variety of interconnected modules that perform the functions and steps discussed above. In particular, some embodiments may include an information receiving module 410 that receives the property information that is inputted and/or uploaded to the value return system 200 or software package (e.g., by the user). Once the information is received, the information receiving module 410 may transfer the information to a service contract feature and package display module 420. The service contract feature and package display module 420 may then display a list of the service contract options (e.g., appliances and utilities to cover, length of service contract, etc.), service contract packages, base coverage, and upgrade options for the property.

After the user selects the service contract features and coverage options or service contract package they wish to obtain for the property, a service contract documentation preparation module 425 may prepare the contract documentation (e.g., description of coverage, terms and conditions, etc.) and a service contract module 430 may then provide the user (e.g., the contract purchaser, seller, or contract holder) with the service contract coverage and any related materials (e.g., terms and conditions, home service contract agreement, service contract coverage, etc.). As described above, once the service contract module 430 provides the user with the service contract the property may be considered “under service contract.”

Once the service contract coverage has started, a status check module 440 may check the status of the service contract including whether or not the contract holder has made any claims. For example, the system 400 may include a claim module 450 that receives information regarding any claims made by the contract holder. The claim module may then, in turn, send the claim information to the status check module 440. To aid in the checking process, the status check module 440 may also have a timer module 445 that keeps track of the service contract period and how long it has been since the start of service contract coverage, expiration of the predetermined period of time, and/or the last claim made by the contract holder. In embodiments that base the additional value on whether a paid claim has been made, the status check module 440 may also determine if the claim is a paid claim.

The status check module 440 may then determine when and if the contract holder has qualified for an additional value. If the contract holder has qualified for an additional value, the status check module 440 may send the appropriate information (e.g., owner contact information, type of additional value earned, etc.) to the notification/additional value module 460, which, in turn, may make the additional value available to the contract holder, and provide the contract holder with the additional value (e.g., at the request of the contract holder). In embodiments in which the contract holder need not request the additional value (e.g., it is provided automatically), the notification/additional value module 460 may also notify the contract holder that they have qualified for the additional value.

Although the above described embodiments primarily provide the benefits of the service contract and additional value to those contract holders that have either purchased a new home or to existing home owners (e.g., those not selling their property), other embodiments may provide similar coverage to sellers. For example, if a seller (or their real estate agent or other representative) purchases a service contract for a home they are selling (e.g., to make the home more attractive to buyers), the seller may obtain the primary benefits of the service contract (e.g., the appliances or systems may be covered under the service contract if they fail), as well as the additional value if they do not make a claim or a paid claim within a predetermined period of time. In other words, if the property does not sell and the seller does not make a claim or a paid claim within the predetermined period of time, the seller may receive, for example, a free maintenance visit (or other additional value). Additionally, once the property sells and the buyer becomes the contract holder, the buyer may receive the benefits (e.g., coverage and additional values) of the service contract.

It is important to note that embodiments of the present invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

For example, a pseudo code representation of a generic embodiment might be set forth as follows:
provide contract purchaser with service contract on property;
   check status of the home service contract
   monitor contract term, time since start of contract, and expiration of predetermined time
   determine if claim made by contract holder
      if claim=no and time since start of contract>predetermined period of time
         then offer contract holder additional value.

In accordance with other embodiments, the invention may be implemented as a computer program product for use with a computer system, such as the workstations 210 shown in FIG. 2. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may either be a tangible medium (e.g., optical or analog communications lines) or a medium implemented with wireless techniques (e.g., microwave, infrared or other transmission techniques). The series of computer instructions embodies all or part of the functionality previously described herein with respect to the system. For example, the series of computer instructions may be a computer program that may be installed on one or more of the workstations 210. The installed program may then perform the functions described above. For example, the software program may present the user with a graphical interface and a series of templates to facilitate the necessary data input and selection of home service contract options and packages. The software program or home service contract provider may then provide the user/owner with the service contract and/or additional value.

Those skilled in the art should appreciate that such computer instructions/software programs can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer systems (e.g., on system ROM or fixed disk), or distributed from a server or electronic bulletin board over the network (e.g., the Internet or World Wide Web). Additionally or alternatively, the instructions may be stored within a memory located within the workstations 210 or the server 250 and may be executable by one or more processors located within the workstation 210 of server 250.

What is claimed is:

1. A system for providing a value returned home service contract comprising:
a processor; and
a memory storing instructions executable by the processor to perform processes that include:
providing, to a contract purchaser, a service contract on at least one property owned by a contract holder;
checking a status of the home service contract to determine whether a claim has been made by the contract holder within a predetermined period of time; and
making an additional value available to the contract holder if the contract holder does not make a claim within the predetermined period of time.

2. A system according to claim 1, wherein the contract purchaser is the contract holder.

3. A system according to claim 1, wherein the memory further stores instructions executable by the processor to perform processes that include:
receiving and processing claims made by the contract holder; and
determining when the contract holder makes a claim within the predetermined period of time.

4. A system according to claim 1, wherein the processor includes a timer, the timer tracking a term of the service contract and the predetermined period of time.

5. A system according to claim 1, wherein the predetermined period of time is the first nine months of a term of the home service contract.

6. A system according to claim 1, wherein the additional value is at least one selected from the group consisting of a free maintenance visit on a home system, a free maintenance visit on a home appliance, a cash-back reward, an extension of a term of the service contract, a free energy audit, and a rebate on future repairs.

7. A system according to claim 1, wherein the home service contract is a multi-year service contract.

8. A system according to claim 1, wherein the home service contract does not cover at least one of missing appliances, missing home systems, rust and corrosion, and abuse to the home.

9. A system according to claim 1, wherein the claim is a paid claim.

10. A system according to claim 1, wherein a remainder of the service contract remains after the predetermined period, the contract holder being able to make claims during the reminder of the home service contract and after receiving the additional value.

11. A system according to claim 1, wherein a cost of the home service contract is independent from an age and condition of the property.

12. A system for providing a value returned home service contract comprising:
means for providing, to a contract purchaser, a service contract on at least one property owned by a contract holder;
means for checking a status of the home service contract to determine whether a claim has been made by the contract holder within a predetermined period of time; and
means for offering the contract holder an additional value if the contract holder does not make a claim within the predetermined period of time.

13. A system according to claim 12, wherein the contract purchaser is the contract holder.

14. A system according to claim 12, further comprising:
means for receiving and processing claims made by the contract holder, the means for receiving and processing claims notifying the means for monitoring when the contract holder makes a claim within the predetermined period of time.

15. A system according to claim 12, wherein the means for monitoring includes a means for tracking a term of the service contract and the predetermined period of time.

16. A system according to claim 12, wherein the predetermined period of time is within the first nine months of a term of the home service contract.

17. A system according to claim 12, wherein the additional value is at least one selected from the group consisting of a free maintenance visit on a home system, a free maintenance visit on a home appliance, a cash-back reward, an extension of a term of the service contract, a free energy audit, and a rebate on future repairs.

18. A system according to claim 12, wherein the home service contract is a multi-year service contract.

19. A system according to claim 12, wherein the home service contract does not cover at least one of missing appliances, missing home systems, rust and corrosion, and abuse to the home.

20. A system according to claim 12, wherein the claim is a paid claim.

21. A system according to claim 12, wherein a remainder of the service contract remains after the predetermined period, the contract holder able to make claims during the reminder of the home service contract and after receiving the additional value.

22. A system according to claim 12, wherein a cost of the home service contract is independent from an age and condition of the property.

23. A computer-implemented method for providing a value returned home service contract comprising:
providing, using a computer, a contract purchaser with a service contract on at least one property owned by a contract holder;
checking, in a computer process, a status of the home service contract to determine whether a claim has been made by the contract holder within a predetermined period of time; and
offering, using a computer process, the contract holder an additional value if the contract holder does not make a claim within the predetermined period of time.

24. A computer-implemented method according to claim 23, wherein the contract purchaser is the contract holder.

25. A computer-implemented method according to claim 23, wherein the predetermined period of time is within the first nine months of a term of the home service contract.

26. A computer-implemented method according to claim 23, wherein the additional value is at least one selected from the group consisting of a free maintenance visit on a home system, a free maintenance visit on a home appliance, a cash-back reward, an extension of a term of the service contract, a free energy audit, and a rebate on future repairs.

27. A computer-implemented method according to claim 23, wherein the home service contract is a multi-year service contract.

28. A computer-implemented method according to claim 23, wherein the home service contract does not cover at least one of missing appliances, missing home systems, rust and corrosion, and abuse to the home.

29. A computer-implemented method according to claim 23, wherein the claim is a paid claim.

30. A computer-implemented method according to claim 23, wherein a remainder of the service contract remains after the predetermined period, the contract holder able to make claims during the reminder of the home service contract and after receiving the additional value.

31. A computer-implemented method according to claim 23, wherein a cost of the home service contract is independent from an age and condition of the property.
